(19) United States
(12) Patent Application Publication
(10) Pub. No.: US 2006/0274709 A1
(43) Pub. Date: Dec. 7, 2006

(54) Communication link connection indication signal method and apparatus

(75) Inventor: Brockett Muir III, Upperville, VA (US)

Correspondence Address: Fitch, Even, Tabin & Flannery, Suite 1600, 120 South LaSalle Street, Chicago, IL, 60603-3406, US

(73) Assignee: ENDTONE, LLC, Upperville, VA (US)

(21) Appl. No.: 11/437,754

(22) Filed: May 18, 2006

Related U.S. Application Data
(60) Provisional application No. 60/686,759, filed on Jun. 2, 2005.

(51) Int. Cl. H04B 7/216

(52) U.S. Cl. 370/342

(57) ABSTRACT

Upon detecting (11) at a two-way communication device that a communication link has been established, the two-way communication device can provide (14) a unique corresponding signal (such as a unique audible signal) to indicate such connection. Pursuant to one approach, a plurality of such unique signals (13) are available and a specific one of the available signals is selected (12) for use in a given circumstance using a selection criteria of choice.

### CROSS REFERENCE TO RELATED APPLICATIONS

This application claims the benefit of priority under 35 U.S.C. § 119(e) to U.S. Provisional application Ser. No. 60/686,759, filed Jun. 2, 2005.

### TECHNICAL FIELD

This invention relates generally to communication link usage and more particularly to communication link status indication.

### BACKGROUND

Communication devices comprise a generally well-understood area of endeavor including, but not limited to, two-way communications based upon, for example, wireless cellular telephony and the like. In many communication systems the system infrastructure will assign or otherwise facilitate the allocation of wireless resources (such as, but not limited to, radio frequency carriers, time slots, spreading codes, and so forth) to support a given communication session. The constituent elements and the totality of such allocated wireless resources can be viewed as a communication link.

There are times when confusion can arise with respect to whether a given communication link has, in fact, become connected. For example, a given user may perceive, incorrectly, that a given communication link has been connected but fail to take an appropriate action to actually effect the connection of that communication link. This, in turn, can lead to user frustration, inefficient use of resources and wasted time.

### BRIEF DESCRIPTION OF THE DRAWINGS

The above needs are at least partially met through provision of the communication link connection indication signal method and apparatus described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, upon determining that a communication link for a communication device is connecting (and/or connected) or otherwise being successfully established, a unique corresponding signal is provided at the communication device to indicate connection or establishment of that communication link. In a preferred approach the corresponding signal is unique in that the signal is not used for other annunciation or notice purposes. For example, the communication device will not use this signal to also indicate the disconnection of a communication link.

In a preferred approach the unique signal comprises an audible and/or video signal. In an optional, but preferred approach, a plurality of candidate unique signals are available at the communication device. So configured, a user, for example, can select particular candidate unique signals to use in particular circumstances or settings to customize their user experience to their satisfaction. The unique signal itself can comprise any of a wide variety of audible, video or other content, including but not limited to musical content, verbal content, sound effects content, and so forth.

So configured, a user will receive a positive indication whenever a communication link being used by their communication device connects to a point of network attachment or is otherwise established or completed. This, in turn, can be used to assure the user that the communication link is, in fact, operational at times when the user expects the communication link to be operational. If desired, these assurances are delivered in a customized and pleasing fashion that enhances and personalizes the user experience

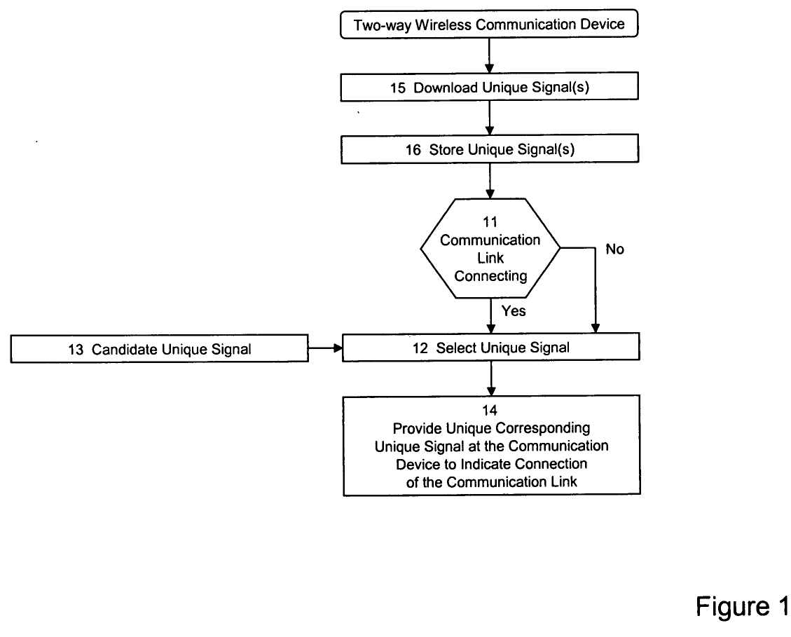

These and other benefits may become clearer upon making a thorough review and study of the following detailed description. Referring now to the drawings, and in particular to FIG. 1, a two-way communication device of choice (such as, but not limited to, cellular telephones, computers, and other two-way radios of various kinds and types, including platforms having voice and/or data modes of operation) detects 11 when a communication link is connecting. This can comprise, for example, determining at the communication device itself that a wireless communication link is connecting.

Various kinds of communication links are known in the art and consequently the details regarding detecting the connection of any particular communication will necessarily differ with variations in the enabling technology as will be well understood by those skilled in the art. In many cases the communication device will become aware of such connection when an otherwise absent signal (such as a carrier signal, a pilot signal, a handshake signal, or other expected and recurrent signal) becomes present.

In the absence of detecting such connection, the communication device can provide a unique failure attempt signal and continue with its other usual and ordinary activities. Upon detecting such connection, however, the communication device can optionally select 12 a unique signal (for example, from amongst a plurality of candidate unique signals 13). The unique signal will comprise, in general a user-discernable signal such as a unique auditory signal, visual signal, or haptic sensation (such as a vibration pattern).

In a preferred approach the unique signal comprises an audible signal. The audio signal content itself can comprise any known or hereafter-developed audio signal content including but not limited to a monophonic series of tones, a polyphonic series of tones, and/or digitized audio (such as MP3-compatible digitized audio). Such audio signal content examples are all well understood in the art and require no further elaboration here. In a preferred approach such an audible signal can comprise any audible content that is capable of uniquely identifying a connection event as disclosed below. A non-exhaustive listing of representative examples would include:
a commercial jingle;
a commercial tagline;
a sound sample;
a sound effect sample;
verbal content; and
music (including both instrumental music and music featuring sung lyrics).

The signal can essentially have any desired duration. In many cases, it may be preferable to have a relatively short unique signal having a duration that does not exceed some predetermined maximum duration (such as, for example, three seconds, ten seconds, three minutes, and so forth).

When a plurality of such unique signals are available to a given communication device, this selection step 12 will typically comprise selection of a particular signal from amongst the plurality of available signals. The selection criteria itself can vary with the needs and/or requirements of a given application and setting. To illustrate, one can select a particular unique signal from amongst a plurality of available unique signals as a function, at least in part, of at least one of:

a specific other communication party (for example, a specific one of the available unique signals can be used when signaling the connection of a communication link with respect to a particular other party);

a time of day (for example, one unique signal might be used to indicate connection of communication links as may occur prior to noon and another, different unique signal might be used to indicate connection of communication links as may occur following noon);

a random selection amongst the available unique signals;

the type of communication link that has been connected (for example, one unique signal might be used to indicate connection of a cellular communication link and another, different unique signal might be used to indicate connection of a Bluetooth communication link);

to name but a few.

Pursuant to these teachings, the communication unit then provides 14 a unique corresponding signal at the communication device to indicate connection of the communication link. In a preferred approach the provided unique signal will comprise the previously selected unique signal when a particular signal has been optionally selected from amongst a plurality of unique signals as described above. Various ways are known in the art to effect the provision of such unique signals as are mentioned above. Furthermore, these teachings are not particularly sensitive to the selection and/or use of any particular approach in this regard. Therefore, for the sake of brevity and the preservation of narrative focus, further detailed description of such techniques will not be provided here.

As a more specific example, these teachings can be employed to facilitate a unique audible notice as to when a wireless communication link has become connected for whatever reason (for example, regardless of whether the link has been initiated by the two-way device itself or has been initiated by another party). More particularly, at least one audible signal can be provided at a two-way wireless communication device, which audible signal is uniquely used to identify connection of the wireless communication link but which is not to be used to identify other events, conditions, and/or states at this communication device. Upon then detecting at the two-way wireless communication device that a given wireless communication link has been connected, the audible signal can be rendered audible to thereby provide a unique audible signal to a user of the two-way wireless communication device that the given wireless communication link has been connected.

Those skilled in the art will recognize that there are various ways to provision such a two-way communication device with one or more such unique signals. Pursuant to one approach, the device can simply be loaded with one or more such signals as a factory preset. Pursuant to another approach, and referring now again to FIG. 1, one or more such unique signals can optionally be downloaded 15 to the two-way communication device. Such downloading can be facilitated in any of a wide variety of manners in accordance with well understood prior art technique, including by transmission of the corresponding data to the two-way communication device using a wireless carrier channel.

Upon downloading such a signal, it will then typically be desirable to store 16 the downloaded unique signal for future use. Such storage can be conditioned as desired. For example, a pre-established limit may be provided to prevent storage and/or use of the downloaded signal beyond a given date, time, or event. In other cases, it may be preferable to permit unconditioned use of downloaded unique signals.

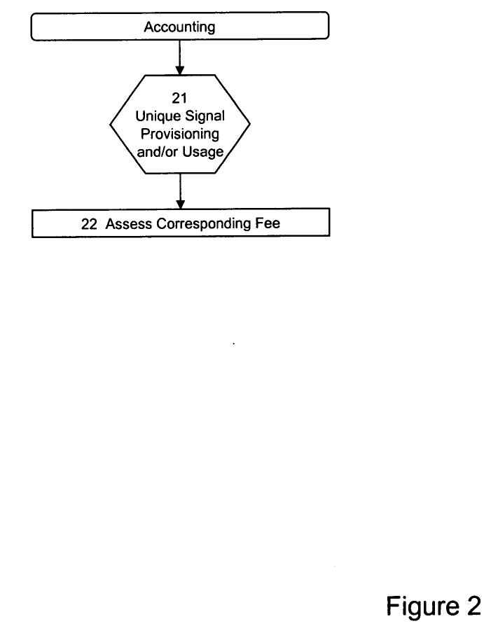

Optionally, and referring now to FIG. 2, upon provisioning and/or being otherwise informed of usage of such unique signals 21 with respect to a given two-way communication device, an appropriate accounting platform for the service provider can facilitate assessing 22 a corresponding fee. For example, a specific one-time fee may be assessed for each downloaded unique signal. As another example, a fee may be assessed for each time the unique signal is used by a given two-way communication device. As yet another example, a monthly fee may be assessed for so long as a given communication device retains the stored unique signal. Other possibilities exist as well as will be well recognized by those skilled in the art.

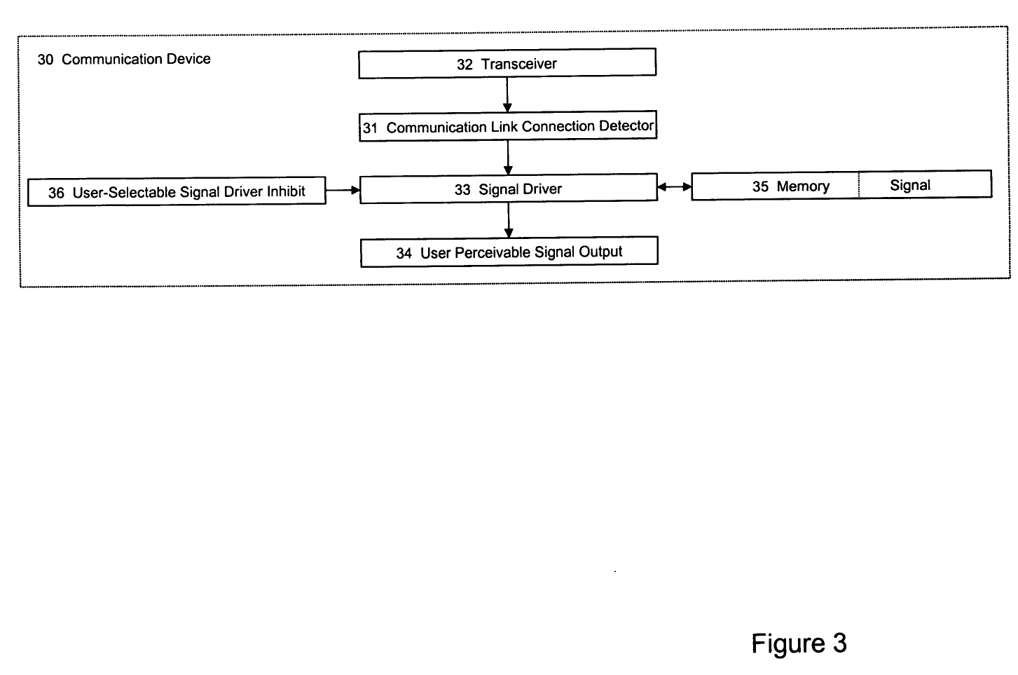

As noted above, these teachings can be usefully employed in conjunction with a wide variety of communications platforms. In many cases, as will be well understood by those skilled in the art, modern communication devices comprise partially or even wholly programmable platforms that can be readily configured to adopt and implement the described functionality. As a more specific illustrative example, and referring now to FIG. 3, a given communication device 30 can comprise, in relevant part, a communication link connection detector 31 of choice that operably couples to, for example, a transceiver 32. So configured, the communication link connection detector 31 serves, at least in part, to monitor the operation of the transceiver 32 and in particular to detect when a communication link (such as a wireless communication link) has been connected for whatever reason.

The communication link connection detector 31, in turn, operably couples to a signal driver 33 such as, in a preferred approach, an audible signal driver. The latter serves to drive a user perceivable signal output 34 of choice and as may be appropriate to compatibly audibilize the signal content of choice. In a preferred approach, the signal driver 33 operably couples to a memory 35 having one or more audible signals stored therein. So configured, the signal driver 33 can select a particular one of a plurality of stored audible signals when the memory 35 has a corresponding plurality of such signals stored therein.

So configured, those skilled in the art will understand and appreciate that such an apparatus will readily detect the connection of a communication link and respond to such detection by providing a signal, such as an audible signal, that uniquely identifies the communication link connection event. This, in turn, permits a user of the device to be well informed with respect to the presence and/or absence of a viable communication link and can use and leverage that understanding with follow-on actions of choice to best accommodate a given condition.

There may be times, however, when a user may wish to temporarily defeat the above-described operability. For example, a given user may wish to disable this capability for some period of time while engaged in a particular activity or while visiting a particular venue. As another example, a given user may wish to effect an early conclusion of a provided signal during playback. To accommodate such a need, if desired, a user-selectable signal driver inhibit 36 can be operably coupled to the signal driver 33 to permit and facilitate such an action. Such a mechanism can assume any suitable form factor and human-machine interface of choice, including but not limited to push buttons, sliding switches, touch screen displays, a voice recognition interface, and so on.

It should now be evident and clear that these teachings permit a user to be apprised of when a communication link, such as a wireless communication link, has been connected, created, or otherwise established. This information can be used in various ways. In particular, such an indication can be used to correctly inform a user who otherwise incorrectly believes that a given communication link is available and active. Many users will appreciate that such information, important in and of itself, is also capable of being delivered in a personalized and highly customizable manner. Those skilled in the art will appreciate that these benefits are attainable with little fundamental change to many communication devices being necessary. In general, these teachings can be implemented in a highly cost effective manner.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
determining that a communication link for a communication device is connecting;
in response to determining that the communication link is connecting, providing a unique corresponding signal at the communication device to indicate connection of the communication link.

2. The method of claim 1 wherein determining that a communication link for a communication device is connecting comprises determining that a wireless communication link is connecting.

3. The method of claim 1 wherein determining that a communication link for a communication device is connecting comprises determining, at the communication device, that the communication link is connecting.

4. The method of claim 1 wherein providing a unique corresponding audible signal at the communication device comprises retrieving audio signal content from a memory and using the audio signal content to provide the unique corresponding audible signal.

5. The method of claim 4 wherein retrieving audio and/or video signal content from a memory comprises retrieving at least one of:
a monophonic series of tones;
a polyphonic series of tones;
digitized audio;
digitized video.

6. The method of claim 5 wherein the digitized audio comprises MP3-compatible digitized audio.

7. The method of claim 1 wherein providing a unique corresponding signal at the communication device comprises providing at least one of:
a commercial jingle;
a commercial tagline;
a sound sample;
a sound effect sample;
verbal content;
music;
a user-discernable haptic sensation.

8. The method of claim 1 further comprising:
downloading the unique corresponding signal at the communication device to provide a downloaded unique signal.

9. The method of claim 8 further comprising:
storing the downloaded unique signal.

10. The method of claim 1 wherein providing a unique corresponding signal at the communication device to indicate connection of the communication link comprises selecting the unique corresponding signal from amongst a plurality of available candidate unique corresponding signals.

11. The method of claim 10 wherein selecting the unique corresponding signal from amongst a plurality of available candidate unique corresponding signals comprises selecting the unique corresponding signal from amongst a plurality of available candidate unique corresponding signals as a function, at least in part, of at least one of:
a specific other communication party;
a time of day;
a random selection;
a type of communication link.

12. A communication device comprising:
a communication link connection detector;
at least one stored audible signal;
an audible signal driver that is operably coupled to the at least one stored audible signal and that is responsive to the communication link connection detector, such that the audible signal driver causes the at least one stored audible signal to be rendered audible in response to connection of a communication link.

13. The communication device of claim 12 wherein the communication link connection detector comprises means for detecting connection of a communication link.

14. The communication device of claim 13 wherein the means for detecting connection of a communication link comprises means for detecting connection of a wireless communication link.

15. The communication device of claim 12 wherein the at least one stored audible signal comprises at least one of:
a monophonic series of tones;
a polyphonic series of tones;
digitized audio;
digitized video.

16. The communication device of claim 12 wherein the at least one stored audible signal comprises a plurality of stored audible signals and wherein the audible signal driver comprises means for selecting a particular one of the plurality of stored audible signals to render audible in response to connection of a communication link.

17. The communication device of claim 12 further comprising a user-selectable audible signal driver inhibit that is operably coupled to the audible signal driver.

18. A method of facilitating an audible notice as to when a wireless communication link is connected, comprising:
providing at a two-way wireless communication device at least one audible signal to be used to identify connection of the wireless communication link but which is not to be used to identify other events, conditions, and states;
detecting at the two-way wireless communication device that a given wireless communication link has been connected;
in response to detecting connection of the given wireless communication link, rendering the at least one audible signal audible to provide a unique audible signal to a user of the two-way wireless communication device that the given wireless communication link has been connected.

19. The method of claim 18 wherein the at least one audible signal has a duration of less than a predetermined maximum duration.

20. The method of claim 18 further comprising:
assessing a fee as corresponds to at least one of providing and using the at least one audible signal.
